(19) United States
(12) Patent Application Publication
(10) Pub. No.: US 2008/0244127 A1
(43) Pub. Date: Oct. 2, 2008

(54) COMPUTER INTERFACE CONTROLLER FOR PORTABLE PLUG-AND-PLAY PERIPHERALS

(75) Inventor: Cheng-Hung Huang, Banciao City (TW)

Correspondence Address: VENABLE LLP, P.O. BOX 34385, WASHINGTON, DC, 20043-9998, US

(73) Assignee: Tenx Technology Inc., Banciao City (TW)

(21) Appl. No.: 11/694,480

(22) Filed: Mar. 30, 2007

(51) Int. Cl. G06F 3/01

(52) U.S. Cl. 710/105

(57) ABSTRACT

The computer interface controller for portable plug-and-play peripherals of this invention comprises:
a computer interface control means to communicate with and to control the output and input of data to and from a computer through a computer communication interface;
a micro size controller to control the peripheral application functions of the computer interface controller, to process the communications of data and to transmit information;
a driver program memory to store the driver programs of the peripherals; and
a virtual optical disc drive controller to announce a virtual optical disc drive to the computer so to enable the driver program memory to function as a virtual optical disc drive in relation to the computer, whereby the driver programs provided in the driver program memory may be provided to the computer in order to drive the peripheral.

### FIELD OF THE INVENTION

The present invention related to a computer interface controller for portable plug-and-play peripherals, especially to a computer interface controller embedded with the driver programs of the portable peripherals. In the computer interface controller of this invention, a single chip integrated structure is provided, whereby a plurality of USB data transmission interfaces are included and multiple functionalities are integrated into a single chip.

### BACKGROUND OF THE INVENTION

In the portable consumer products, there are some problems to be solved. The first problem is in the manufacturing costs. Although a number of products, such the UART, mouse, keyboard, etc. peripherals, may use the same interface device or interface protocol to communicate with the computer, in each of these products one such computer interface device shall be installed. As a result, the consumers need to pay the costs of the same computer interface device for each of the peripherals. Another problem is in the power consumption. Most portable peripherals need to obtain the power supply from the computer in which the portable peripherals operates. When a plurality of the portable peripherals is in connection with the computer, the computer must supply electric power to these peripherals at the same time. That these peripherals may use the same computer interface device does not change this fact. The notebook computer is also a portable device. To save the power consumption is also an important task in the design of the notebook computer. If a peripheral consumes too much electric power, using such a peripheral in a notebook computer would definitely shorten the operable time of the computer. In order to reduce the costs of the portable peripherals and to save their power consumption, a computer interface controller in which a plurality of peripherals that use the same interface device is integrated, so that the plurality of peripherals may operate with the computer through the integrated interface controller, would be desirable.

In addition, among the many computer interface standards and specifications the USB standard is the most popular. In most high-end consumer products, such as the digital camera, the mobile phone handset, the MP3 player, the PDA, the game console etc., the USB interface device has been equipped. It may be predicted that in the coming years, the USB interface device will be equipped in almost all the high-end products and most of the middle-level products. The market of the low-end products is a market of greater potential yet to be developed. A peripheral product provided with the USB interface controller is of higher values than the competing products, because its users may enjoy the convenience of the USB interface and the high-leveled integration and the editablility of the computerized documents. However, under the conventional art, before a peripheral that uses the USB interface device (the “USB product”) may operate in a computer, the user is required to install the driver program into the computer. For most users and for all the peripheral manufacturers this requirement is the major drawback and problem of the USB products.

In other words, most consumer electronic products that use the USB interface may not operate with the operating system of the computer directly. An optical disc that contains the driver program of the USB product is provided along with the product so that the user may use an optical disc drive in connection with the computer in which the USB product will operate to read the driver program and to install the driver program in the computer. For the users, it is not convenient to install the driver in such an “indirect” way, at least for the following reasons. First, no user would carry the optical disc along with the USB product. The optical disc is not designed as a “portable” device. Without the optical disc, the USB product is not as portable as it is designed to be, since it can not be “plugged-and-played” in a computer in which the driver of the USB product is not installed in advance. Secondly, after the driver program is installed in one computer, the optical disc becomes useless and would be put away carelessly. When the user needs to install the driver in another computer, it would be very difficult to allocate the optical disc. Last but not least, in the installation of the driver the driver program is copied into the hard disc drive of the computer and will reside in the operating system program of the computer. It does not unnecessarily occupy the system resources but will also be enacted whenever the computer is restarted, causing the starting time of the computer unnecessarily long.

It is thus necessary to provide a novel computer interface controller that may simplify the installation of the portable peripherals that use the computer interface, such as the USB interface.

### OBJECTIVES OF THE INVENTION

The objective of this invention is to provide a novel computer interface controller for the peripheral devices.

Another objective of this invention is to provide a computer interface controller for the portable plug-and-play peripherals.

Another objective of this invention is to provide computer interface controller for portable plug-and-play peripherals, in which a virtual optical disc drive is embedded.

Another objective of this invention is to provide computer interface controller for portable plug-and-play peripherals, which automatically installs the driver of the peripherals in the computer.

Another objective of this invention is to provide a USB interface controller for portable plug-and-play peripherals, in which a plurality of devices that use the USB interface is integrated.

### SUMMARY OF THE INVENTION

In order to realize the above-mentioned objectives, the present invention provides a single chip integrated structure, in which a plurality of USB data transmission interface devices and a virtual optical disc drive are provided, so to provide a computer interface controller with the plug-and-play functionality. According to the computer interface controller for portable plug-and-play peripherals of this invention, the computer interface controller comprises:

a computer interface control means to communicate with and to control the output and input of data to and from a computer through a computer communication interface;

a micro size controller to control the peripheral application functions of the computer interface controller, to process the communications of data and to transmit information;

a driver program memory to store the driver programs of the peripherals; and

a virtual optical disc drive controller to announce a virtual optical disc drive to the computer so to enable the driver program memory to function as a virtual optical disc drive in relation to the computer, whereby the driver programs provided in the driver program memory may be provided to the computer in order to drive the peripheral.

In the present invention, the computer interface may be any communication interface that enables the peripheral to communicate with the computer. However, in the embodiments of the present invention, the computer interface is the USB interface. The micro size controller may be any commercialized microcontroller or microprocessor.

The computer interface controller for portable plug-and-play peripherals of this invention may further comprise a bulk transfer endpoint to access bulk data in the peripherals. For a consumer product that does not use the standard computer interface, the bulk transfer endpoint provides the higher data transmission rates than the ordinary transfer endpoints.

The computer interface controller for portable plug-and-play peripherals of this invention may further incorporate an upload endpoint device and/or an upload and download endpoint device, to announce to the computer standard peripherals such as a standard keyboard device or a standard mouse, so that the peripherals in connection with the computer interface controller may operate in the computer without the need of installing their drivers. In addition, the computer interface controller for portable plug-and-play peripherals may also include a bidirectional data transmission interface device, in which a plurality of bidirectional data transmission interfaces is embedded, so that the computer interface controller of this invention may be used in the peripherals that require the application of the bidirectional data transmission. The bidirectional data transmission interfaces may include: The SPI interface, the SmartCard reader interface, the UART interface, the GPIO interface etc.

These and other objectives and advantages of the present invention may be clearly understood from the detailed descriptions by referring to the following drawings.

### BRIEF DESCRIPTION OF THE DRAWINGS

FIG. 1 illustrates the block diagram of the computer interface controller for portable plug-and-play peripherals of this invention.

FIG. 2 shows the flowchart of the communication interface negotiations of the computer interface controller for portable plug-and-play peripherals of this invention.

### DETAILED DESCRIPTION OF THE INVENTION

The computer interface controller for portable plug-and-play peripherals of the present invention will be described in the followings by illustrating its embodiments. The present invention provides a novel structure of the computer interface controller, which is rather different from that of the conventional art. In the present invention, a plurality of data transmission interfaces and a plurality of functions are integrated into one single computer interface controller for portable plug-and-play peripherals. A virtual optical disc drive is provided in the computer interface controller to complete the installation and the operations of the driver programs, whereby the computer interface controller may operate in a “plug-and-play” manner.

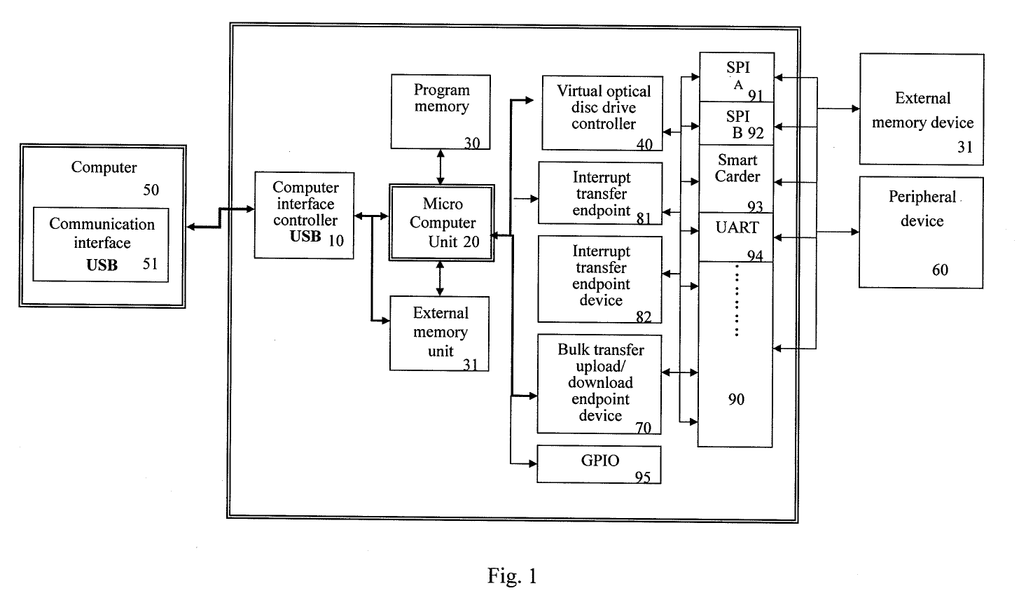

FIG. 1 illustrates the block diagram of the computer interface controller for portable plug-and-play peripherals of this invention. As shown in the figure, the computer interface controller 1 of this invention controls the communications and the input and output between a peripheral device 60 and a computer 50. The computer interface controller 1 includes:

a computer interface control means 10 to communicate with and to control the output and input of data to and from the computer 50 through a computer communication interface 51;

a micro size controller 20 to control the peripheral application functions of the computer interface controller 1, to process the communications of data and to transmit information;

a driver program memory 30 to store the driver programs of the peripheral device 60; and

a virtual optical disc drive controller 40 to announce a virtual optical disc drive to the computer 50 so to enable the driver program memory 30 to function as a virtual optical disc drive in relation to the computer 50, whereby the driver programs provided in the driver program memory 30 may be provided to the computer 50 in order to drive the peripheral device 60.

In the above-described system, the computer interface 51 may be a USB interface, since the USB interface is currently the most popular communication interface between the peripheral and the computer. Of course, other standard computer interfaces, such as the wired communication interfaces including the PCMCIA interface, the CardBus interface, the IEEE1394 interface, the PCI interface etc. and the wireless communication interfaces including the infrared, the Bluetooth and radio communication may also be applied in the present invention. Since the control and the circuit of the computer interface controller 10 are known to those skilled in the art, detailed descriptions thereof are thus omitted.

The micro size controller 20 may be any commercially available microcontroller or microprocessor. For those skilled in the art, it is possible for them to design a micro size controller 20 to satisfy the requirements of the computer interface controller of this invention. However, it would be practicable to obtain the licenses from the designer of a commercially available microcontroller or microprocessor the right to use the core of the microcontroller or microprocessor in the computer interface controller of this invention. The major functions of the micro size controller 20 are to process the data generated by the computer interface control means 10, to conduct necessary operations and to output data to its peripherals. The control and the circuit of the micro size controller 20 are known to those skilled in the art. Detailed descriptions are thus omitted.

The virtual optical disc drive controller 40 is one of the major features of this invention. The virtual disc drive controller 40 announces to the computer 50 the existence of a virtual optical disc drive, whereby the computer 50 will generate a communication channel for the virtual optical disc drive. The computer 50 will treat the driver program memory 30 as an optical disc drive, so that the driver program memory 30 may provide the driver program to the computer 50, to be installed in the hard disc drive (not shown) of the computer 50. It is also possible not to install the driver program in the computer 50 but, instead, provide the computer 50 to access the driver program from time to time.

In another embodiment of the present invention, the driver program memory 30 may be any memory module that may be prepared in the controller chip. It may be a read only memory or a rewritable memory. In a further embodiment of this invention, an external memory device 31 is used to store the driver programs. In this case, the virtual optical disc drive controller 40 uses the external memory device 31 as the driver program memory to store the executable files and provide the driver programs to the computer 50 in the form of a virtual optical disc drive. External memory devices suited in this invention include but not limit the serial flash memory, the NOR type flash memory, memory card etc.

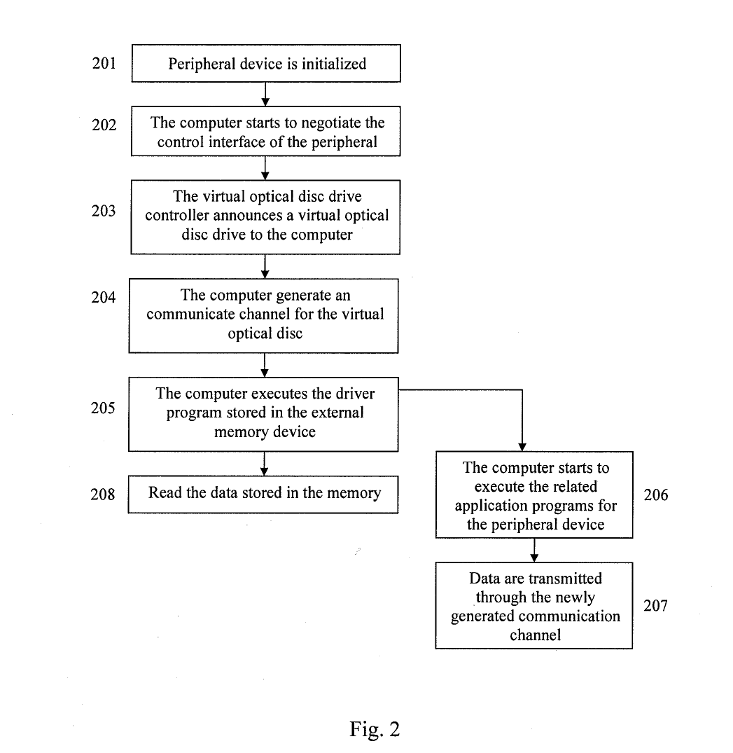

The virtual optical disc drive controller 40 of this invention enables any peripheral product 60 that does not use any of the standard interfaces to negotiate and to communicate with the computer 50 as if it is an optical disc drive of the standard interface. Through this communication channel, the application software stored in the driver memory 30 may be executed by the computer 50, and the negotiations of communication interface between the peripheral 60 and the computer 50 may be completed. The flows of the negotiation are shown in FIG. 2. FIG. 2 shows the flowchart of the communication interface negotiations of the computer interface controller for portable plug-and-play peripherals of this invention.

As shown in FIG. 2, at 201, the user inserts the peripheral device 60, including the computer interface controller 1, into the interface device 51 of the computer 50, whereby the computer 50 senses the existence of the peripheral 60 and the connection of the peripheral 60 and the computer 50 is initialized. At 202, the computer 50 starts to negotiate the control interface of the peripheral 60. At 203, the virtual optical disc drive controller 40 announces a virtual optical disc drive to the computer 50. At 204, the computer generates an interface channel for the virtual optical disc. At 205, the computer executes the driver program stored in the driver program memory 30. At 206, the computer starts to execute the related application programs of the peripheral device 60. The application programs provide other data transmission channels, for example, other USB data transmission interfaces. Through the other data transmission channels the user may upload and down load data to and from the computer 50. Thereby, at 207, the data are transmitted through the newly generated communication channel. If the computer does not execute the application programs at 205, the computer may, at 208, read the data stored in the memory 40 or 41, which was defined as a virtual optical disc drive, or write data into the memory 40 or 41, through the communication channel generated for the virtual optical disc drive.

When a peripheral device uses the computer interface controller of this invention, the immediate advantage is the costs of the driver disc may be saved. It will be not necessary for the user to carry the driver disc whenever the user travels. The peripheral device may operate in any computer without the need of installing the driver program. Other drawbacks of the conventional computer interface controller will no longer exist.

Under the design of the present invention, the computer interface controller uses the computer interface to communicate with the computer, then announces a virtual optical disc drive to the computer to establish a communication channel with the computer. The driver programs of the peripheral devices are stored in the embedded virtual optical disc drive or the external memory and are provided to the computer through the communication channel. The executable programs stored in the driver program memory 30 do not have to be installed or reside in the computer system. The user may execute the application programs stored in the virtual optical disk drive directly. No unnecessary burdens are added to the computer. After the computer starts to execute the application programs in the virtual optical disc drive, the application program will use their particular communication channels to upload or download data, instead of through the communication channel of the virtual optical disc drive.

In the implementation of the controller IC of the present invention, the memory module can be either OTP or Flash or Mask process. The peripheral device makers may determine the specifications of the IC depending on the functional requirements of different products and the customer's requests.

In the computer interface controller for portable plug-and-play peripherals of this invention, a bulk transfer upload/download endpoint device 70 may be provided. The bulk transfer upload/download endpoint device 70 may request and obtain from the computer 50 a communication channel to upload and download bulk data, whereby the user may store and access a large number of data in the peripheral device 60. For a consumer product that does not use any of the standard interface devices, the bulk transfer upload/download endpoint device 70 may provide a higher data transmission rate than those of the ordinary data transmission endpoints. The bulk transfer upload/download endpoint device 70 is particular useful in the case when the peripheral device 60 is a memory or a peripheral device having a memory.

The computer interface controller for portable plug-and-play peripherals of this invention may further provide an upload endpoint device 81 and/or an upload and download endpoint device 82, to announce a standard peripheral device, such as a standard keyboard, a standard mouse or the like, to the computer 50. Upon such announcement, a communication channel in the announced protocol will be generated so that the peripheral may operate in the computer 50 without the need of installing the driver programs in the computer 50, in case the peripheral device 60 is a mouse or a keyboard. In addition, the computer interface controller for portable plug-and-play peripherals 1 may further include a bidirectional data transmission interface device 90, in which a plurality of bidirectional data communication interfaces is embedded. The directional data communication interfaces may be used by the peripheral devices with the directional data transmission functions and may include 2 SPI interfaces 91 and 92, 1 SmartCard reader interface 93, 1 UART interface 94, 1 GPIO interface 95 etc. These interfaces or modules are known to those skilled in the art. Detailed descriptions thereof are thus omitted.

In a computer interface controller with all or parts of the above-mentioned devices or interfaces a plurality of control interfaces for the peripheral devices has been integrated. The computer interface controller may be used by a variety of peripheral devices. The peripheral device makers may use the present invention as the computer interface controller for a single-function product or a hybrid-function product. The user will no longer need to install the driver program whenever the peripheral is operated in a new computer. A useful and integrated computer interface controller is thus realized.

As the present invention has been shown and described with reference to preferred embodiments thereof, those skilled in the art will recognize that the above and other changes may be made therein without departing from the spirit and scope of the invention.

What is claimed is:

1. A computer interface controller for portable plug-and-play peripherals of this invention, the computer interface controller comprises:
a computer interface control means to communicate with and to control the output and input of data to and from a computer through a computer communication interface;
a micro size controller to control the peripheral application functions of the computer interface controller, to process the communications of data and to transmit information;
a driver program memory to store the driver programs of the peripherals; and
a virtual optical disc drive controller to announce a virtual optical disc drive to the computer so to enable the driver program memory to function as a virtual optical disc drive in relation to the computer, whereby the driver programs provided in the driver program memory may be provided to the computer in order to drive the peripheral.

2. The computer interface controller for portable plug-and-play peripherals according to claim 1, wherein said computer interface is the USB interface.

3. The computer interface controller for portable plug-and-play peripherals according to claim 1, wherein said micro size controller is one selected from the group consisted of microcontroller and microprocessor.

4. The computer interface controller for portable plug-and-play peripherals according to claim 1, further comprising a bulk transfer node device to enable the access of a memory device.

5. The computer interface controller for portable plug-and-play peripherals according to claim 1, further comprising an upload endpoint device to announce to said computer a standard peripheral device, wherein said standard peripheral is selected from the group consisted of a standard mouse and a standard keyboard.

6. The computer interface controller for portable plug-and-play peripherals according to claim 1, further comprising an upload and download endpoint device, to announce to said computer a memory device.

7. The computer interface controller for portable plug-and-play peripherals according to claim 1, further comprising a bidirectional data transmission interface device wherein a plurality of bidirectional data transmission interfaces is embedded.

8. The computer interface controller for portable plug-and-play peripherals according to claim 7, wherein said bidirectional data transmission interface comprises at least two selected from the group consisted of the SPI interface, the SmartCard reader interface, the UART interface and the GPIO interface.

9. The computer interface controller for portable plug-and-play peripherals according to claim 1, wherein said driver program memory is an external memory device.

10. The computer interface controller for portable plug-and-play peripherals according to claim 9, wherein said external memory device comprises at least one selected from the group consisted of the serial flash memory, the NOR type flash memory and the memory card.
